(19) United States
(12) Patent Application Publication
(10) Pub. No.: US 2013/0243291 A1
(43) Pub. Date: Sep. 19, 2013

(54) METHOD AND DEVICE FOR PROCESSING A COMPUTER TOMOGRAPHY MEASUREMENT RESULT

(71) Applicants: Gupta Varsha, Singapore (SG); L Nowinski Wieslaw, Singapore (SG)

(72) Inventors: Gupta Varsha, Singapore (SG); L Nowinski Wieslaw, Singapore (SG)

(73) Assignee: Agency for Science, Technology and Research, Singapore (SG)

(21) Appl. No.: 13/696,594

(22) PCT Filed: May 12, 2011
(86) PCT No.: PCT/SG2011/000184

§ 371 Date: Jan. 28, 2013

(30) Foreign Application Priority Data
May 14, 2010 (SG) 201003436-1

(51) Int. Cl. G06T 7/00

(52) U.S. Cl. CPC G06T 7/0012
USPC 382/131

(57) ABSTRACT

According to one embodiment, a method for processing a computed tomography measurement result is described, the computed tomography measurement result comprising an intensity for each voxel of a plurality of voxels, wherein the method comprises determining, for each intensity of a range of intensities, the number of voxels of the plurality of voxels for which the intensity has been determined; and determining a characteristic of a target body region based on the determined numbers of voxels of the plurality of voxels.

### FIELD OF THE INVENTION

Embodiments of the invention generally relate to a method and a device for processing a computed tomography measurement result.

### BACKGROUND OF THE INVENTION

Accurate and prompt detection of an acute infarct based on an unenhanced computed tomography (CT) scan result is typically of high importance for decision making in the emergency room. Due to limited quality of CT images, there are practically no automated approaches for unenhanced CT scans. Moreover, the sensitivity of unenhanced CT results in detecting stroke is very low. Reliable methods for determining characteristics of body regions, e.g. determining whether a body region is afflicted by an illness such as an infarct, are desirable.

### SUMMARY OF THE INVENTION

In one embodiment, a method for processing a computed tomography measurement result is provided, the computed tomography measurement result including a intensity for each voxel of a plurality of voxels, wherein the method includes: determining, for each intensity of a range of intensities, the number of voxels of the plurality of voxels for which the intensity has been determined and determining a characteristic of a target body region based on the determined numbers of voxels of the plurality of voxels.

### SHORT DESCRIPTION OF THE FIGURES

Illustrative embodiments of the invention are explained below with reference to the drawings.

FIG. 1 shows a flow diagram according to an embodiment.

FIG. 2 shows a processing device according to an embodiment.

FIG. 3 shows a flow diagram according to an embodiment.

FIG. 4 shows a flow diagram according to an embodiment.

FIG. 5 shows a first histogram and a second histogram according to an embodiment.

FIG. 6 shows a first histogram and a second histogram according to an embodiment.

FIG. 7 shows a flow diagram according to an embodiment.

FIG. 8 shows a diagram of CTp values according to an embodiment.

FIG. 9 shows a flow diagram according to an embodiment.

FIG. 10 illustrates the correlation of n_ratio with the infarct volume.

FIG. 11 illustrates correlation between the value of n_ratio and the slice ground truth area (for the axial case).

FIG. 12 gives an illustration to show localization of cuboids, estimating maximum area slice and volume.

FIG. 13 illustrates an example of two cuboid regions (with inner higher confidence and outer lower confidence).

FIG. 14 illustrates the correlation of the volume of the inner cuboid and the ground truth volume.

### DETAILED DESCRIPTION

According to one embodiment, an automated approach to identify an infarct region, localize an infarct region and estimate spatial characteristics of an infarct region (generally a target body regions such as a body region afflicted by an illness) based on (unenhanced) computed tomography scans is used. According to one embodiment, a parameter (denoted in the following as CT parameter or as CTp) is determined based on a change in histogram characteristics of unenhanced CT images in the parenchyma intensity range. The change in the shape of histogram when a part of parenchyma is replaced by an acute infarct region is according to one embodiment captured through the change in percentile distribution, mean intensity and the ratio of number of voxels in different intensity ranges. The CT parameter is for example used to estimate the acute infarct (brain) hemisphere and the acute infarct slices in axial, coronal and sagittal planes. This enables localization of a cuboid volume of interest encompassing the acute infarct region. Further, according to one embodiment, the change in number of voxels in the acute infarct intensity region is utilized to calibrate it with the ground truth volume of the infarct to construct a model equation to estimate an acute infarct volume without segmenting it. This may be of high importance since there is typically a lot of ambiguity in generating the ground truth regions of acute infarct on unenhanced CT, so validation of infarct segmentation may be questionable. The core of the infarct may be for example estimated from the region of maximum change in CTp in the axial, coronal and sagittal planes. The changes in the number of voxels in the hypointense CSF range may be utilized to detect swelling in the data. A-priori identification, localization, estimation of swelling, acute infarct volume and center according to embodiments can enable doctors in to make quick decisions in the emergency room.

It should be noted that in CT images, intensity is also referred to as “density”. So intensity may also be read as density, intense as dense or intensities as densities.

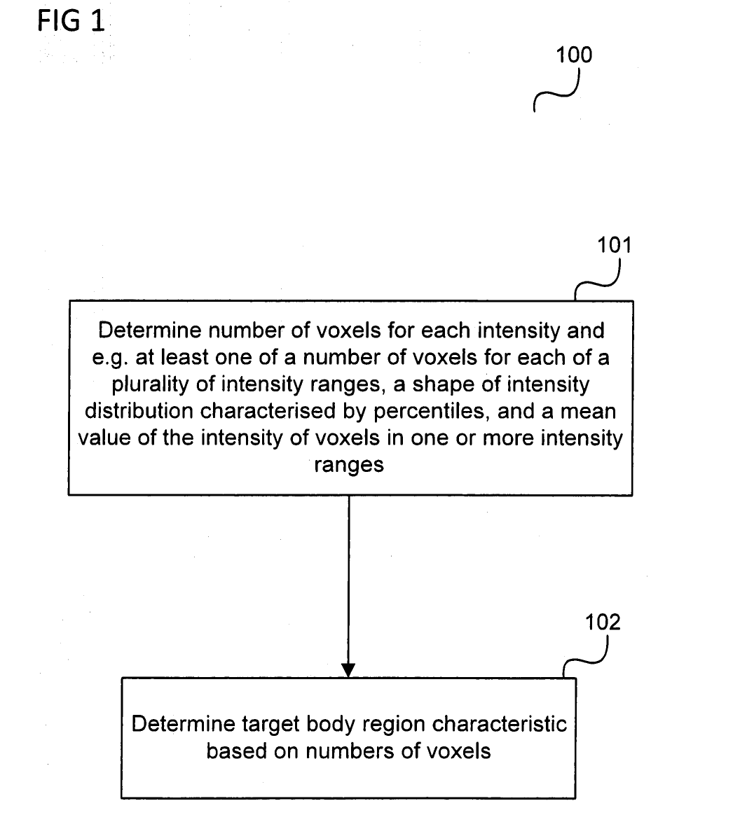

According to one embodiment, a method for processing a computed tomography measurement result is provided as illustrated in FIG. 1.

FIG. 1 shows a flow diagram 100 according to an embodiment.

The flow diagram 100 illustrates a method for processing a computed tomography measurement result, the computed tomography measurement result including an intensity for each voxel of a plurality of voxels.

In 101, for each intensity of a range of intensities, the number of voxels of the plurality of voxels is determined for which the intensity has been determined.

In 102, a characteristic of a target body region is determined based on the determined numbers of voxels of the plurality of voxels.

Illustratively, in other words, it is determined how often, in terms of voxels, each intensity of the range of intensities occurs. This may be seen as a intensity histogram for the body region corresponding to the plurality of voxels (i.e. the body region for which computed tomography data has been generated, e.g. a human head, e.g. a part of the brain such as a brain hemisphere or a brain hemisphere slice). From this intensity distribution a characteristic of a target body region, e.g. the body region or a part of the body region corresponding to the plurality of voxels or a body region including the body region corresponding to the plurality of voxels, is determined, for example by comparing the intensity distribution with a reference intensity distribution, e.g. an intensity distribution that would be expected for the body region, or an intensity distribution of another body region (e.g. another brain part, such as the other brain hemisphere or a slice of the other brain hemisphere).

The computed tomography measurement result may include the intensities for example in the form of grayscale values or also in the form of an absorption coefficient (absorption factor) of a voxel. A voxel can be understood as a “three-dimensional pixel”, in other words an element of a three-dimensional grid, or, equivalently, a volume element in three-dimensional space. A body region may be understood as a part of a body (e.g. a human body). A range of intensities may be understood as a range of intensity values that may be continuous or non-continuous and may be discrete with a certain resolution.

According to one embodiment, the computed tomography measurement result further includes an intensity for each voxel of a further plurality of voxels and wherein the method further includes determining, for each intensity of a range of intensities, the number of voxels of the further plurality of voxels for which the intensity has been determined, comparing the determined numbers of voxels of the plurality of voxels and the determined numbers of voxels of the further plurality of voxels, and determining the characteristic of the target body region based on the result of the comparison.

The further plurality of voxels may for example correspond to another body region than the plurality of voxels, e.g. to (at least a part of) the other brain hemisphere.

The computed tomography measurement result may for example include an intensity for each voxel of a multiplicity of voxels and the method further includes selecting the plurality of voxels and the further plurality of voxels from the multiplicity of voxels. For example, the multiplicity of voxels corresponds to the whole brain and the plurality of voxels and the further plurality of voxels are selected as the brain hemispheres.

In one embodiment, determining the characteristic of the target body region includes determining whether the target body region is afflicted by an illness (or in other words a disease).

Determining the characteristic of the target body region may for example include estimating a size of a part of the target body region.

The part of the target body region is for example a part of the target body region afflicted by an illness (or disease).

According to one embodiment, determining the characteristic of the target body region includes estimating the position of a part of the target body region afflicted by an illness.

The illness (or disease) is for example an infarct.

For example, the target body region is at least a part of the brain, e.g. a brain hemisphere or a slice of a brain hemisphere.

In one embodiment, determining the characteristic of the target body region includes determining whether there is brain swelling in the target body region.

According to one embodiment, determining the characteristic of the target body region includes determining a numerical parameter indicative of the characteristic of the target body region.

Determining the characteristic of the target body region for example includes comparing the determined numerical parameter with a reference value of the numerical parameter.

For example, the reference value of the numerical parameter is a value of the numerical parameter determined for another body region than the target body region.

In one embodiment, the numerical parameter is determined based on the determined numbers of voxels. For example, the numerical parameter is determined based on at least one of a mean of the numbers of voxels over the range of intensities, a median of the numbers of voxels over the range of intensities, a ratio of differences of percentiles of the numbers of voxels over the range of intensities, and a ratio of numbers of voxels of different sub-ranges of the range of intensities.

The method may further include receiving the computed tomography measurement result.

According to one embodiment, a method for processing a computed tomography measurement result is provided, the computed tomography measurement result including an intensity for each voxel of a plurality of voxels, wherein the method includes determining a first subgroup of the plurality of voxels and a second subgroup of the plurality of voxels; determining, for each intensity of a range of intensities, the number of voxels of the first subgroup of voxels for which the intensity has been determined; determining, for each intensity of a range of intensities, the number of voxels of the second subgroup of voxels for which the intensity has been determined; comparing the determined numbers of voxels of the first subgroup and the determined numbers of voxels of the second subgroup; and determining a characteristic of a target body region based on the result of the comparison.

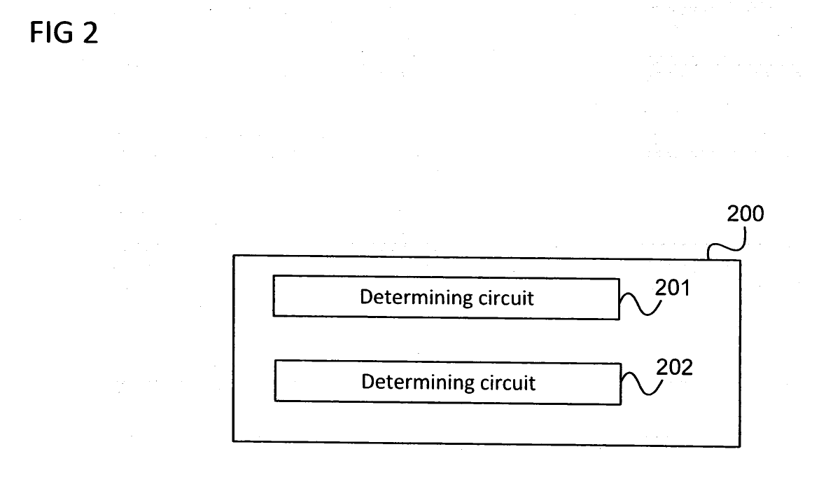

The method described with reference to FIG. 1 is for example carried out by a device as illustrated in FIG. 2.

FIG. 2 shows a processing device 200 according to an embodiment.

The device 200 is a device for processing a computed tomography measurement result, the computed tomography measurement result including an intensity for each voxel of a plurality of voxels.

The device 200 includes a first determining circuit 201, configured to determine for each intensity of a range of intensities, the number of voxels of the plurality of voxels for which the intensity has been determined.

The device 200 further includes a second determining circuit 202 configured to determine a characteristic of a target body region based on the determined numbers of voxels of the plurality of voxels.

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Different circuits can thus also be implemented by the same component, e.g. by a processor executing two different programs. Any other kind of implementation of the respective functions which will be described in more detail below may also be understood as a “circuit” in accordance with an alternative embodiment.

The device 200 may further include an input for receiving the computed tomography measurement result. The device 200 may also include a display for displaying the computed tomography measurement result and for displaying the result of the processing, e.g. an indication of the characteristic of the target body region.

It should be noted that embodiments described in context of the method for processing a computed tomography measurement result are analogously valid for the device for processing a computed tomography measurement result and vice versa. It should further be noted that according to an embodiment, a computer program product which, when executed by a computer, makes the computer perform a method according to one embodiment of the various embodiments is provided.

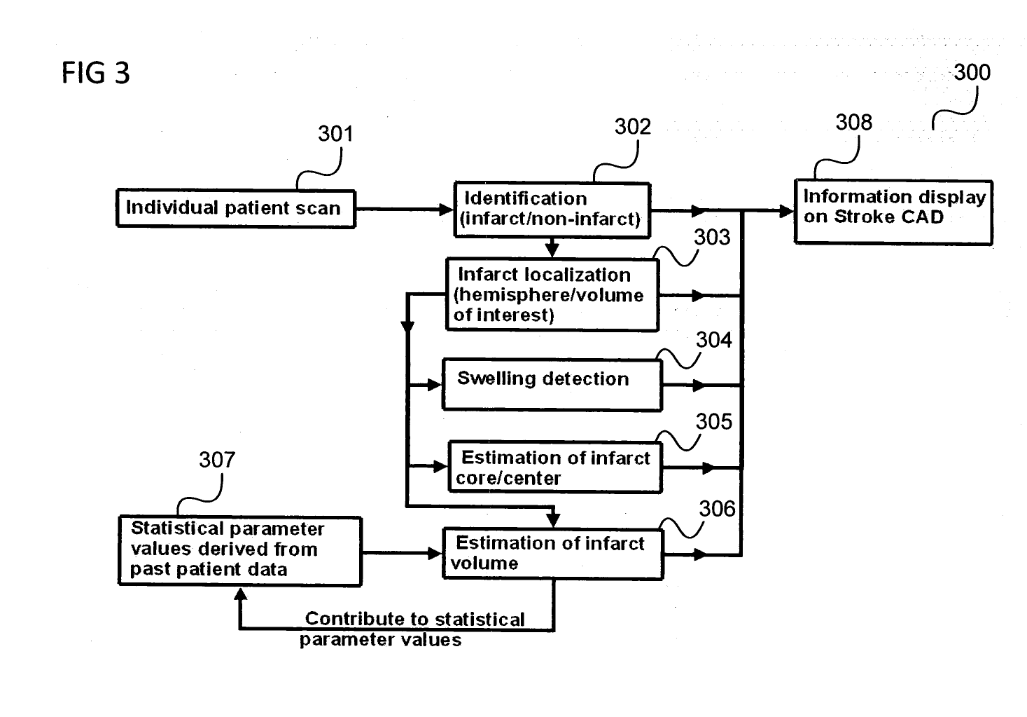

According to one embodiment, a method as illustrated in FIG. 3 is carried out.

FIG. 3 shows a flow diagram 300 according to an embodiment.

In 301, a computed tomography scan of an individual patient is carried out. In other words, a computed tomography measurement is carried out.

In 302, it is determined whether the patient has been afflicted by an infarct. The following is carried out in case that it is determined that the patient has been afflicted by an infarct.

In 303, the afflicted region, for example the afflicted hemisphere or a volume of interest in which the afflicted region is located, is localized.

In 304, it is detected whether there is swelling of the region afflicted by the infarct.

In 305, the core and/or center of the region afflicted by the infarct is estimated.

In 306, the volume of the region afflicted by the infarct is estimated. For the estimation, statistical parameter values derived from past patient data 307 may be used.

The results of all 303 to 306 may be graphically displayed in 308, e.g. as a stroke CAD (computer aided design) image.

According to one embodiment, a computed tomography parameter, referred to as CTp is determined, for example for different body regions (e.g. brain hemispheres) such that information about at least one of the body regions can be determined by comparison. The body region for which the computed tomography parameter is determined (e.g. a brain hemisphere) is referred to as the region of interest (ROI) in the following.

The computed tomography parameter for a body region is for example determined based on a histogram calculated for this body region. The histogram is determined for a range of intensities that is of interest and/or of relevance with regard to the information and/or body region characteristic to be determined.

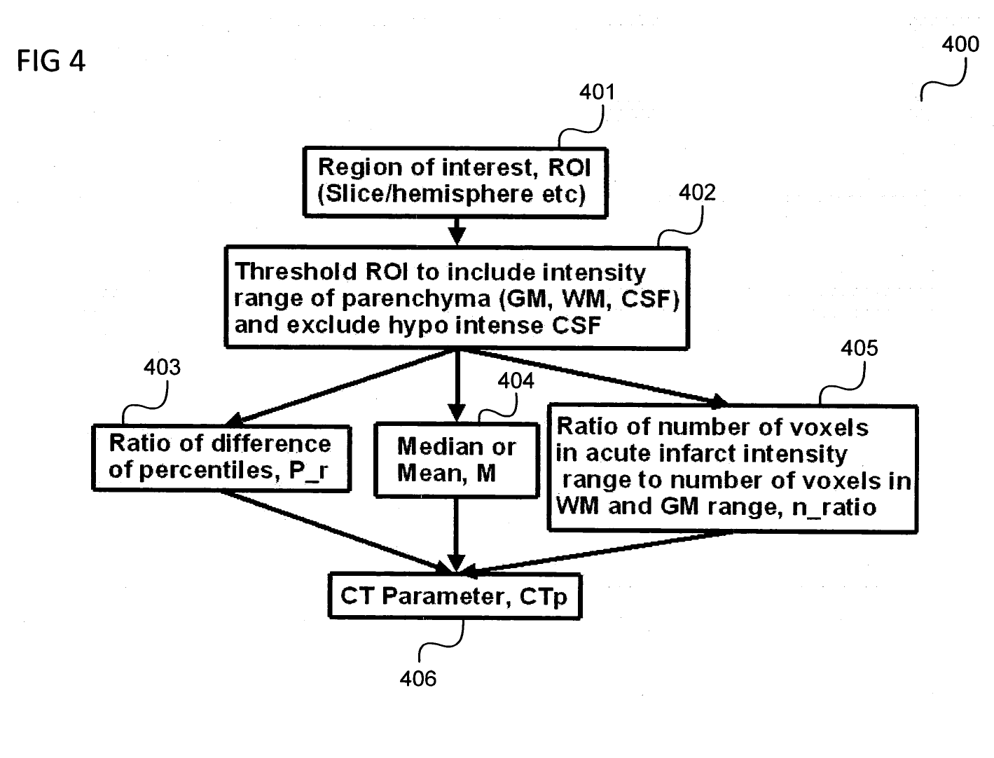

The determination of the computed tomography parameter is for example done according to the flow illustrated in FIG. 4.

FIG. 4 shows a flow diagram 400 according to an embodiment.

In 401, the region of interest is determined, e.g. a slice or a brain hemisphere, etc.

In 402, the intensity range to be studied for the region of interest is set, for example to include the intensities of the parenchyma (including white matter (WM), gray matter (GM), and cerebrospinal fluid (CSF)) and to exclude hypo intense cerebrospinal fluid intensities.

In 403, as described in more detail below, one or more ratios of differences of percentiles of different body regions (e.g. of the two hemispheres) are determined. Such a ratio is denoted by P_r.

In 404, a median or a mean of the intensities of the region of interest (i.e. of the voxels corresponding to the region of interest) is determined.

In 405, the ratio of the number of voxels for which an intensity in the acute infarct intensity range has been determined and the number of voxels for which an intensity in the white matter intensity range and the gray matter intensity range is determined. This ratio is denoted in the following as n_ratio.

In 406, the computed tomography parameter CTp is determined for the region of interest based on at least a part of the results of 403, 404, and 405.

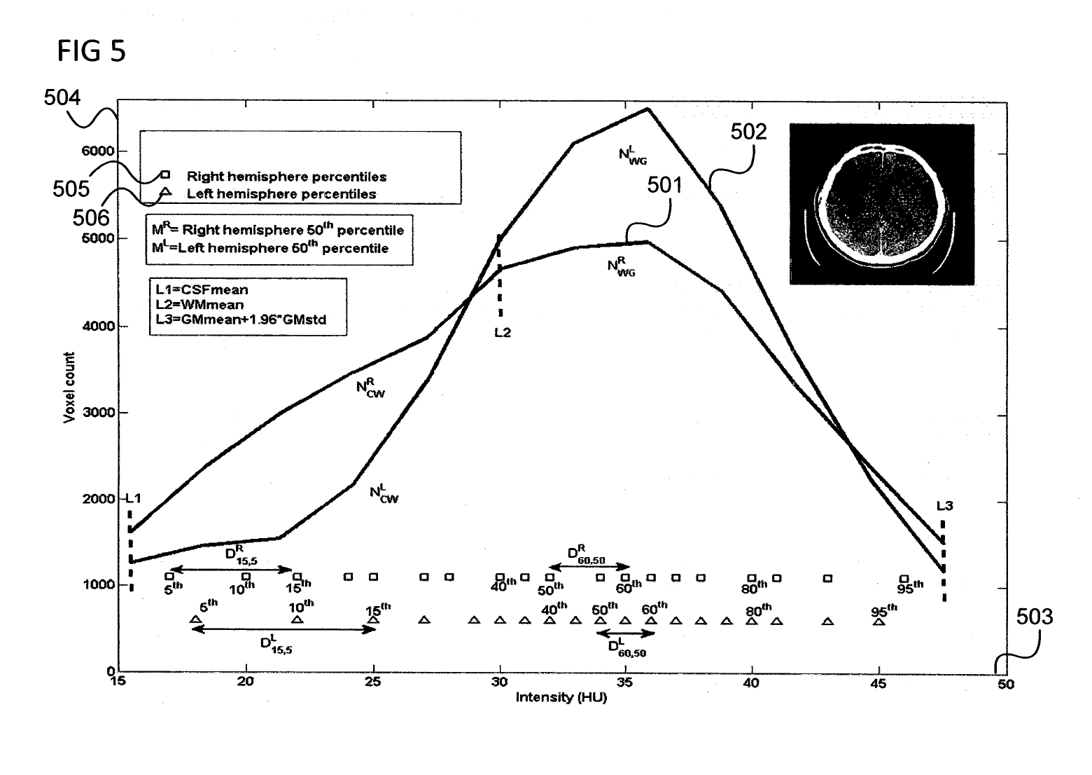

The determination of the various parameters including the computed tomography parameter CTp based on region of interest histograms is explained in more detail in the following with reference to FIG. 5.

FIG. 5 shows a first histogram 501 and a second histogram 502 according to an embodiment.

The histograms 501, 502 illustrate the change in histogram characteristics due to an acute infarct. The regions of interest are in this illustration hemispheres on an axial slice. The first histogram 501 is the histogram for the right hemisphere which is in this example afflicted by an infarct and the second histogram 502 is the histogram for the left hemisphere.

Intensity increases along a horizontal axis 503 and the number of voxels (for which a certain intensity was determined/measured) increases along a vertical axis 504.

To obtain the histograms presented in FIG. 5, the hemisphere intensities are processed to obtain the mean and standard deviation of the intensities of the cerebrospinal fluid (CSF) denoted as (CSFmean, CSFstd), of white matter (WM) denoted as (WMmean, WMstd), and of gray matter (GM) denoted as (GMmean, GMstd).

The hemispheres may be obtained on an axial slice by calculating the midsagittal plane. According to one embodiment, for each hemisphere (i.e. for each region of interest, which may be seen as a sub-group of the total set of voxels), percentiles, mean intensity (or median) and the number of voxels in the acute infarct intensity range are determined. This may be done in the following ways:
(i) Percentile ratios: The region of interest is considered in an intensity range so as to include CSF, WM and GM (and exclude hypo intense CSF), e.g. an intensity range [CSFmean, GMmean+1.96GMstd] (denoted as [L1, L3] in FIG. 5) and the percentiles are determined (indicated by rectangular 505 for the left hemisphere and by triangulars for the right hemisphere in FIG. 5). In CT scans, the mean acute infarct region lies in hyper intense CSF and hypo intense WM intensity range. This is different from MR scans where acute infarcts show up outside the brain parenchyma intensity ranges and focus may be on the changes in the highest percentiles. However in CT, for calculating the percentile ratios, denoted as P_r, focus is according to one embodiment on the changes in lowest to lower middle percentiles. This is because the order of occurrence of acute infarct intensity among the intensities of hyper intense CSF, acute infarct, WM and GM is towards the lower middle intensities. Changes in the intensities of the WM and GM voxels are reflected in the middle to highest percentiles. Different combinations of percentiles differences in numerator and denominator may be considered to derive the maximum significant results. For example, the combinations

$$\frac{{P}_{60} - {P}_{50}}{{P}_{15} - {P}_{5}}$$

may be used as a P_r. In case that there are more voxels due to acute infarct the denominator is decreased and numerator is increased and thus this P_r can be expected to be larger in the infarct hemisphere.
It should be noted that in FIG. 5, D_{15,5}^{R},D_{15,5}^{L} denote the difference between the 15^{th} and 5^{th} percentile for the right (superscript R) hemisphere and left (superscript L) hemisphere, respectively, and D_{60,50}^{R} and D_{60,50}^{L} denote the difference between the 60^{th} and 50^{th} percentile for the for the right (superscript R) hemisphere and left (superscript L) hemisphere, respectively.
(ii) Mean/Median Intensity of Infarct: Typically, the acute infarct causes the mean intensity of the infarct hemisphere to go down (since the GM and WM voxels become hypo intense due to infarction). Therefore, according to one embodiment, the mean intensity of a region of interest is used for determining the CT parameter for the region of interest. Alternatively, the median intensity of the region of interest may be used for determining the CT parameter for the region of interest.
(iii) Ratio of number of voxels. An acute infarction typically leads to voxels in an intensity range interval of about [CSFmean, WMmean], replacing WM and GM intensity voxels. The infarct hemisphere can thus expected to have more voxels in an intensity range interval of about [CSFmean, WMmean] as compared to non-infarct hemisphere (this intensity range is indicated by the range from L1 to L2 in FIG. 5). Similarly, since a loss of voxels in the WM and GM intensity range can be expected, the number of voxels in the infarct hemisphere is typically comparatively lower in this range (which is indicated by the range from L2 to L3 in FIG. 5). So, a ratio of the number of voxels between L1 and L2 (denoted by N_cw) to the number of voxels in the range from L2 to L3 (denoted by N_wg) can be expected to be larger in the infarct hemisphere.
   It should be noted that N_{CW}^{R}, N_{CW}^{L} denote the number of voxels in the intensity range [L1, L2] in the right (superscript R) hemisphere and the left (superscript L) hemisphere, respectively, and N_{wg}^{R}, N_{wg}^{L} denote the number of voxels in [L2, L3] the right (superscript R) hemisphere and the left (superscript L) hemisphere, respectively.
(iv) CT Parameter (CTp): In one embodiment, a CT parameter is defined to characterize the presence of infarct according to

$$CTp = ( \frac{P\_r}{Mn\_cg} ) * ( \frac{N\_cw}{N\_wg} ) \qquad ( 1 )$$

wherein P_r is the ratio of difference of percentiles, Mn_cg is the mean intensity or a median intensity of (the voxels of) the region of interest (e.g. hemisphere), N_cw is the number of voxels in the intensity range mean CSF to mean WM and N_wg is the number of voxels in the intensity range mean WM to upper limit of GM (say GMmean+1.96GMstd)

Equation (1) may be seen as a definition of the CT parameter in rather simple terms. In general, the CT parameter may be defined as a function of a combination

CTp=f(P_{—}r, Mn_{—}cg, N_{—}cw, N_{—}wg) (2)

such that CTp increases (or decreases) due to presence of acute infarct. Also Mn_cg could be a mean or a median, P_r percentile ratio and the intensity ranges of N_cw and N_wg could be variable.

The parameters used in equations (1) and (2) are loosely correlated amongst themselves and a combination of these parameters yields significant difference in infarct and non-infarct regions of interest.

According to one embodiment, it is determined whether a region of interest (in other words a target body region, in this example a brain hemisphere) is affected by swelling. Swelling causes narrowing of cortical CSF regions and ventricles, creating atrophy in the infarct hemisphere and the non-infarct hemisphere. This leads to number of CSF voxels going down in infarct hemisphere. The CSF voxels are replaced by hyper intense voxels (the intensity range of such voxels is unknown).

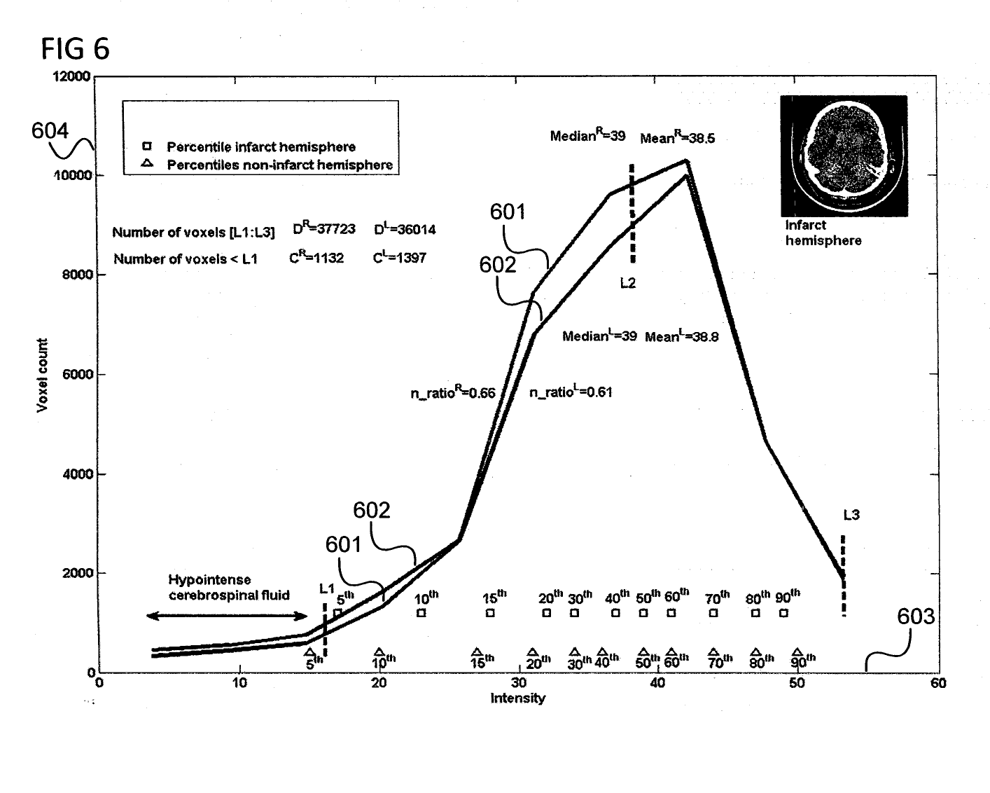

The effects of swelling on the CT intensity histogram are illustrated in FIG. 6.

FIG. 6 shows a first histogram 601 and a second histogram 602 according to an embodiment.

The histograms 601, 602 illustrate the change in histogram characteristics due to swelling. The first histogram 601 is the histogram for the right hemisphere which is in this example afflicted by an infarct and the second histogram 602 is the histogram for the left hemisphere.

Intensity increases along a horizontal axis 603 and the number of voxels (for which a certain intensity was determined/measured) increases along a vertical axis 604.

According to the above, the effects that can be expected in the histogram in the presence of swelling in the intensity range interval [CSFmean−1.96CSFstd, GM+1.96GMstd] as illustrated in FIG. 6 are:
(i) The number of CSF voxels in the infarct hemisphere is reduced as compared to the non-infarct hemisphere below L1 (i.e. CSFmean), i.e. in this hypo intense region. This can be seen from the values C^{R} and C^{L} given in FIG. 6 where superscript R indicates the right hemisphere and superscript L indicates the left hemisphere.
(ii) The hyper intense voxels “created artificially” due to swelling add up all over the histogram (beyond CSF intensity, i.e. >L1). This can be seen from the values D^{R} and D^{L} given in FIG. 6 where superscript R indicates the right hemisphere and superscript L indicates the left hemisphere.

Therefore, to check for any swelling, according to one embodiment, the hypo intense CSF regions (<L1) are considered. So, swelling can be detected and quantified as a function of the number of hypo intense CSF voxels (denoted by C) and number of voxels in the intensity range L1:L3 (denoted by D), i.e. according to

S=g(C,D) (3)

For example, such a function S may be

S=D/C. (4)

For this definition of S, the value of S for the infarct hemisphere is higher than the value of S for the non-infarct hemisphere. For example, in FIG. 6, the value of S for the infarct hemisphere (right) is 33.3 and for the non-infarct hemisphere (left) the value of S is 25.78.

Including swelling information in equation 1 and 2 can further enhance the accuracy of detection of acute infarct. Thus, the CT parameter may be determined as

CTp=fs(P_{—}r, Mn_{—}cg, N_{—}cw, N_{—}wg, S) (5)

According to one embodiment, the CT parameter is used to compare the left hemisphere and the right hemisphere in axial, coronal and/or sagittal planes. According to one embodiment, by definition, the value of CTp is expected to be higher in the infarct hemisphere (or a slice). For example, in accordance with equation (1), due to the presence of infarct P_r and N_cw increase (in the numerator), while the median and N_wg decrease (in the denominator) causing the CTp according to equation (1) to increase in the presence of infarct. According to one embodiment, to locate the infarct slice or hemisphere (or, in other words, to determine the body region afflicted by the infarct) the location (i.e. the region) having the higher value of CTp is determined.

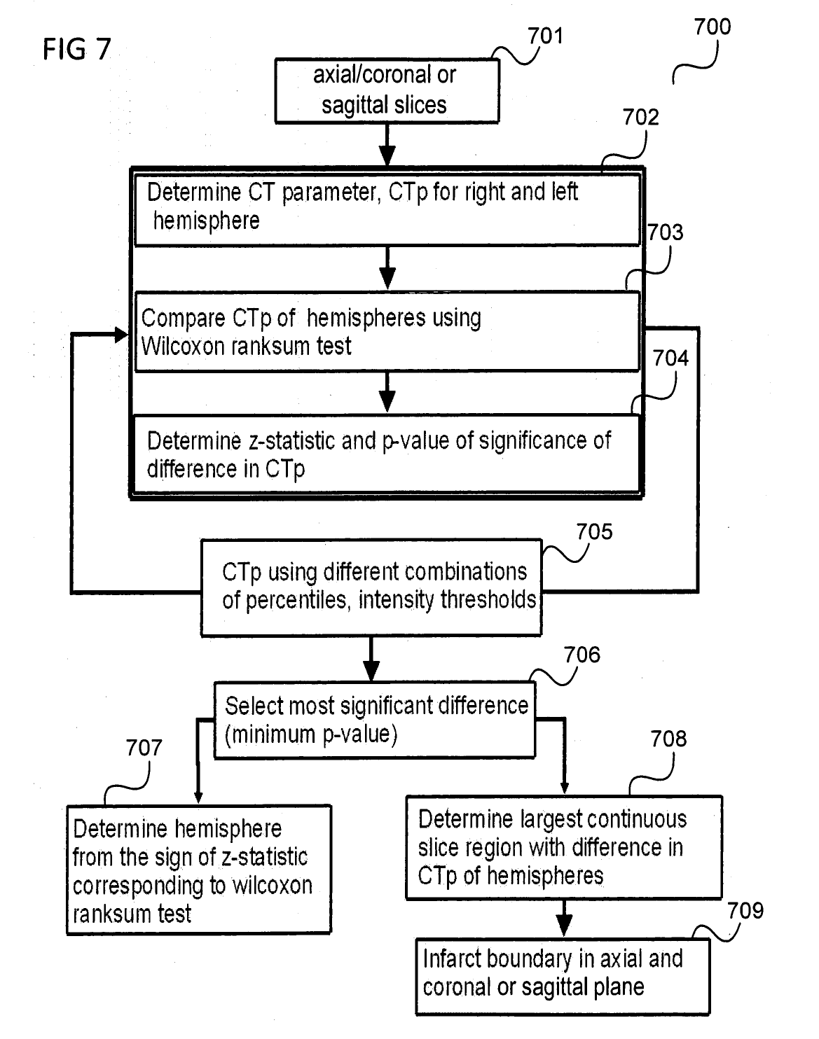

An exemplary flow is illustrated in FIG. 7.

FIG. 7 shows a flow diagram 700 according to an embodiment.

In 701, intensity values for axial/coronal or sagittal slices are determined.

In 702, CTp is calculated for the left hemisphere and the right hemisphere, for example in axial slices.

In 703, the Wilcoxon ranksum test is then conducted on the CTp.

In 704, the sign of the z-statistic and the p-value are noted.

In 705, the CTp is calculated for different combinations of P_r (i.e. for different definitions of P_r, i.e. for different ratio of difference of percentiles) and local variations of threshold intensities are calculated.

In 706, the most significant result (i.e. the minimum p-value) is selected as the final result.

In 707, the infarct hemisphere is determined from the corresponding sign (positive) of the z-statistic which indicates the infarct hemisphere.

The hemisphere may also be localized in coronal slices.

In the sagittal plane, the comparison is performed between whole sagittal slices in the left hemisphere and the right hemisphere.

The slices are found in 708 from the point of intersection of two curves encompassing the maximum number of slices. To locate the maximum number of slices, the minimum slice value and/or the maximum slice value may be determined from different combinations of CTp (corresponding to different thresholds, percentiles etc).

In 709, the infarct boundary in axial/coronal and/or sagittal plane is determined.

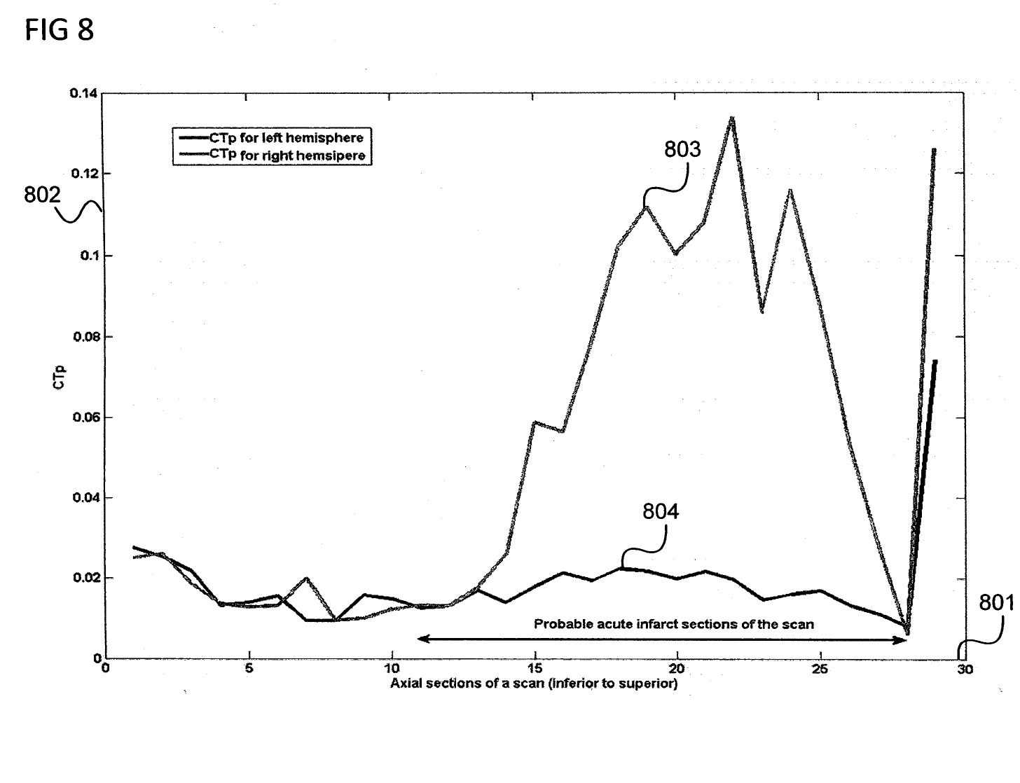

An example for values of the CTp for the case of axial slices is given in FIG. 8.

FIG. 8 shows a diagram of CTp values 800 according to an embodiment.

In the diagram 800, axial slices are numbered from left to right along a first axis 801 and the corresponding CTp values that are given in the diagram 800 increase along a second axis 802.

A first curve 803 indicates the CTp values for the right hemisphere and a second curve 804 indicates the CTp values for the left hemisphere. In this example, by definition, e.g. in accordance with equation (1), the value of CTp is larger for the infarct hemisphere (in this case the right hemisphere).

In this example, the Wilcoxon ranksum test determines the right hemisphere to have larger values of CTp. The largest continuum of slices where the CTp is greater in right hemisphere is from 11 to 28.

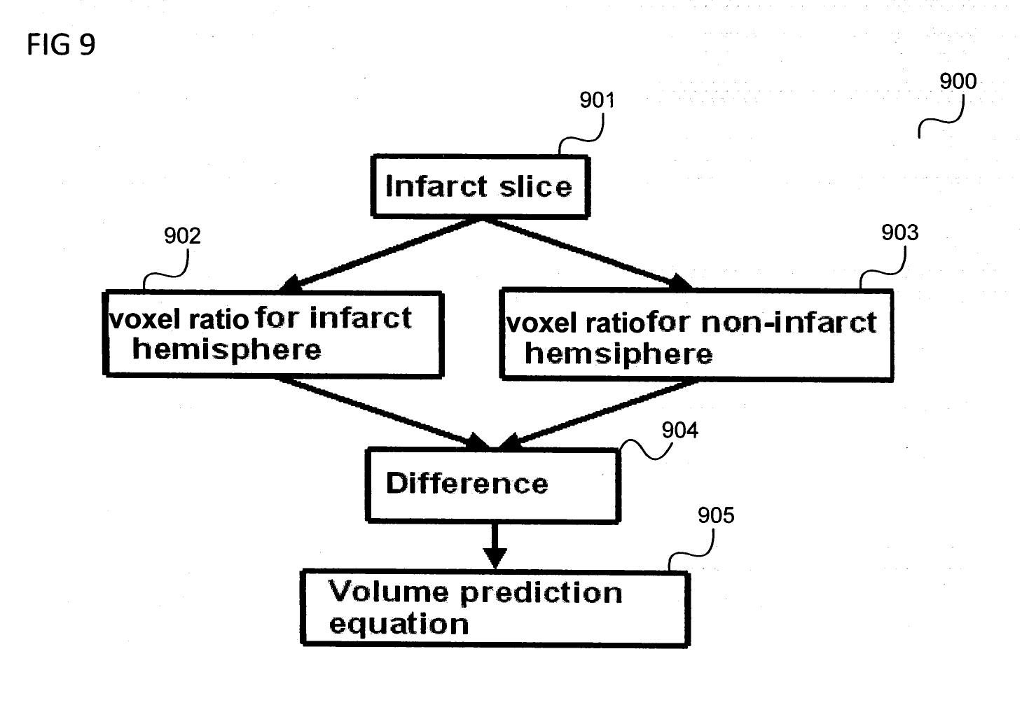

According to one embodiment, the infarct volume is estimated. This is for example carried out as illustrated in FIG. 9.

FIG. 9 shows a flow diagram 900 according to an embodiment.

Referring, as example, to the infarct hemisphere histogram 501 and the non-infarct hemisphere histogram shown in FIG. 5, it can be seen that since an infarct causes hypo intensity in GM and WM voxels, the GM or WM voxel intensity (L2 to L3 range) is replaced by intensity in meanCSF to mean WM range (L1 to L2 range). The number of such voxels can therefore be expected to be proportional to the volume of infarct. The estimate of the number of voxels that might have transferred from intensity range [L2, L3] to [L1, L2] can be obtained by comparison with the non-infarct hemisphere.

Accordingly, according to one embodiment, based on intensities of an infarct slice determined in 901, the number of voxels in the intensity range mean CSF and mean WM is determined for the infarct (right) hemisphere in 902 and the number of voxels in the intensity range mean CSF and mean WM is determined for the non-infarct (left) hemisphere in 903.

In 904, the absolute difference of ratio is determined according to

$$n\_ratio = \vert \frac{{N}^{R} \_cw}{{N}^{R} \_wg} - \frac{{N}^{L} \_cw}{{N}^{L} \_wg} \vert \qquad ( 5 )$$

where N^{R}_cw, N^{L}_cw is the number of voxels in the intensity range mean CSF and mean WM and N^{R}_wg, N^{L}_wg is the number of voxels in mean WM to GM+1.96GMstd.

From a study of the correlation of n_ratio with the ground truth volume it can be seen that as hypothesized, the correlation between the actual volume and the difference of ratio n_ratio is 0.63 (p-value=1.1×10⁻¹³).

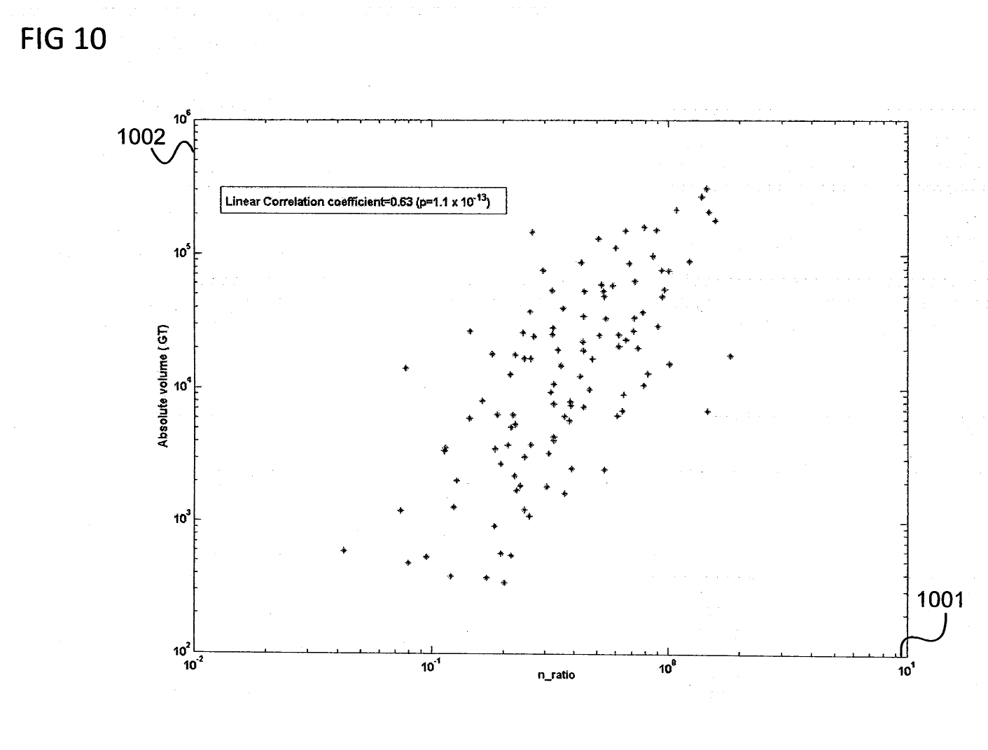

FIG. 10 illustrates the correlation of n_ratio with the infarct volume.

In FIG. 10, n_ratio increases (logarithmically) along a first axis 1001 and the infarct volume increases (logarithmically) along a second axis 1002.

The scatter plot of volume of infarct calculated from n_ratio shown in FIG. 10 can be used to fit a model to estimate the volume of infarct.

For example, a linear polynomial equation can be fit to the correlation data in the log space. The particular sample illustrated in FIG. 10 gives an equation for volume estimation as:

$$V = exp ( {1.579}_{- 0.32}^{+ 0.32} ( log ( n\_ratio ) ) + {10.98}_{- 0.40}^{+ 0.41} ) \qquad ( 6 )$$

which may be used, in 905, to estimate the infarct volume. The parameters or the functional form of equation can change due to larger samples from multiple data centers.

Thus the infarct volume V can be estimated by a general function of n_ratio. For this, equation (6) is just illustrative. Since equation (6) is based on the fact that an infarct leads to voxels in the intensity range interval [L1:L2], say a number of V1 voxels, also deletes the number of voxels in the intensity range [L2:L3], say a number of V2 voxels, another way of volume estimation could be a function of (V1+V2)/2 or any other combination of V1 and V2. In general, any variable could be formulated which compares intensity regions L1:L2 and L2:L3.

According to one embodiment, maximum infarct area slices in axial, coronal and sagittal are determined to estimate the core of the infarct.

The value n_ratio can be utilized to predict a slice with the maximum area as illustrated in FIG. 8 (for an axial slice). In coronal and sagittal plane similar analysis can be performed. The co-ordinate corresponding to the maximum area of the slice is for example the triple M_acs=(maximum area slice in axial, maximum area slice in coronal, maximum area slice in sagittal).

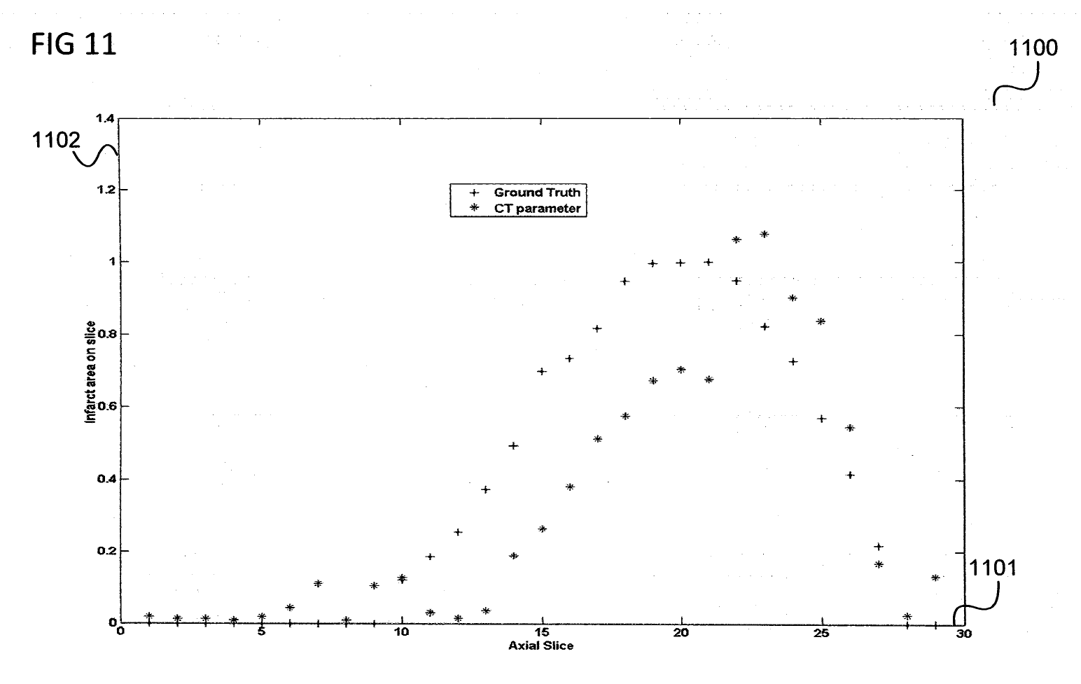

FIG. 11 illustrates correlation between the value of n_ratio and the slice ground truth area (for the axial case).

In FIG. 11, the slice number increases along a first axis 1001 and the infarct are on the respective slice increases along a second axis 1102.

The comparison of the ground truth volume (in terms of infarct area on the slice) with n_ratio of each slice shows a similar trend. Accordingly, according to one embodiment, the shape of the curve and the location of the maximum of the curve is utilized to predict the maximum area of the slice.

As an example, the average sensitivity, specificity and dice index (from 111 cases) of axial slice and hemisphere identification are presented in Table 1.

TABLE 1

| | Sensitivity | Specificity | Dice Index |
|---|---|---|---|
| | (%) | (%) | (%) |
| Section | 90.87 | 71.9 | 72.21 |
| Identification | | | |
| Hemisphere | 86.8 | 86.8 | 86.8 |
| Identification | | | |

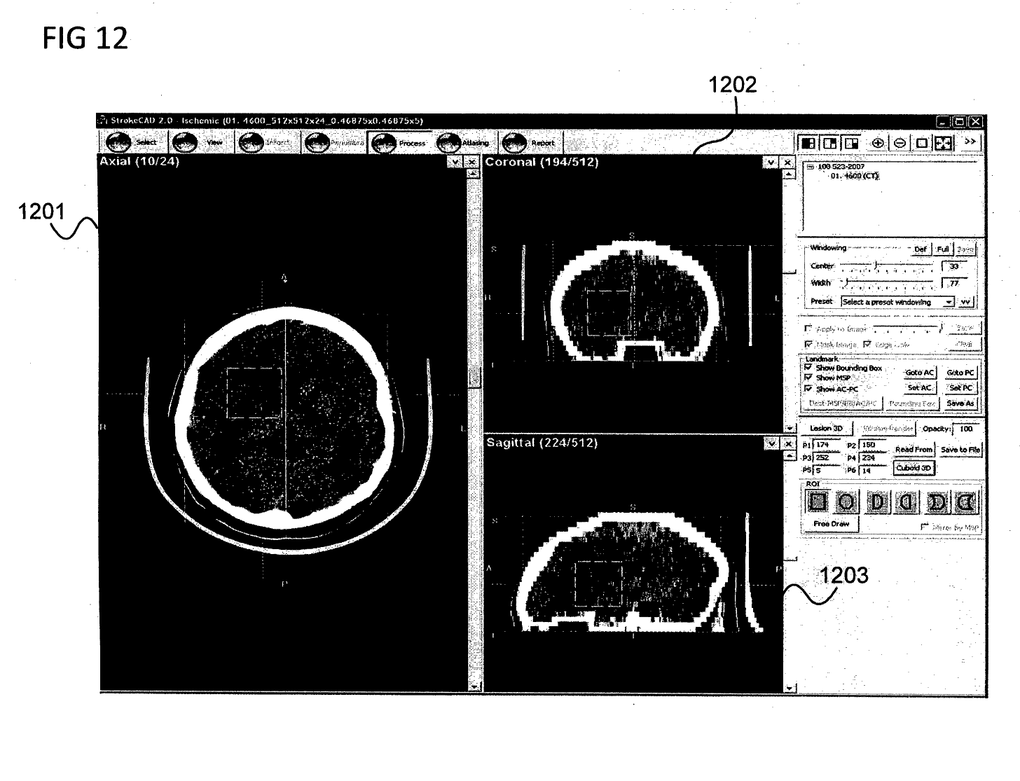

FIG. 12 gives an illustration to show localization of cuboids, estimating maximum area slice and volume.

An axial view 1201, a coronal view 1202, and a sagittal view 1203 are given in FIG. 12.

In this example,
the infarct hemisphere is the right hemisphere
The axial, coronal and sagittal slices are [5,14], [150,234] and [174, 252]
Using the model presented in equation (4) a 95% confidence interval of the volume of the infarct in the range 8.05-10.04 cm³ can be estimated. The volume estimated from the ground truth is 9.09 cm³.
The estimated maximum area slice coordinate is (10, 194, 224).

Multiple cuboid regions may be used to represent the different confidence levels and also to incorporate multiple infarct regions.

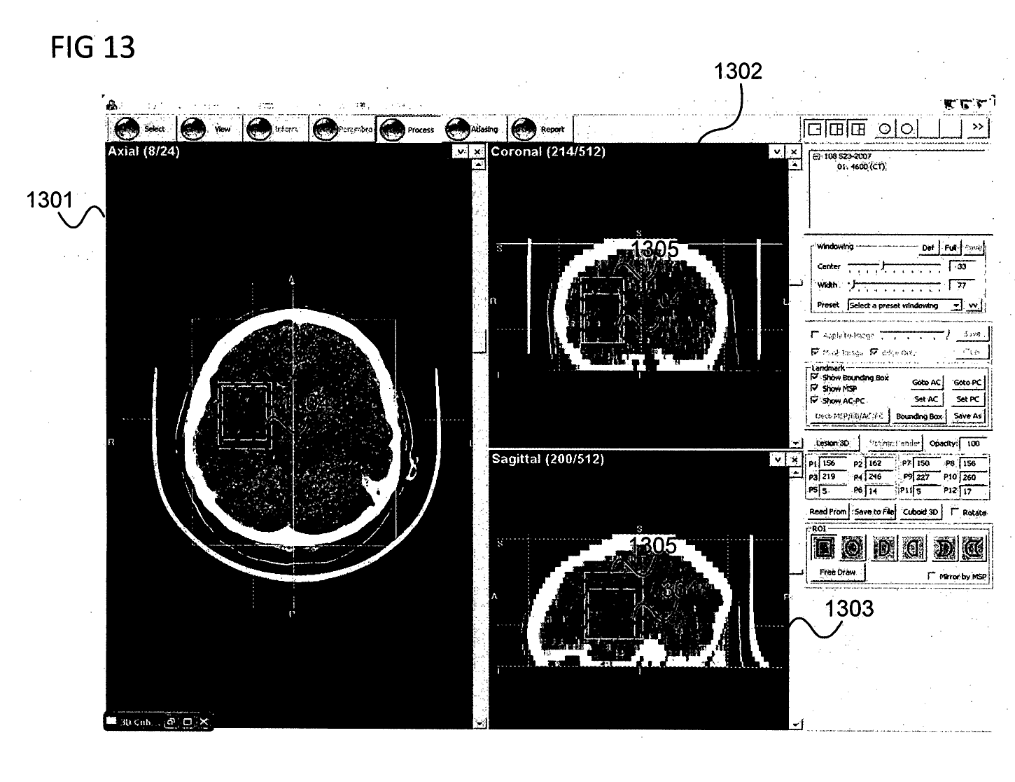

FIG. 13 illustrates an example of two cuboid regions (with inner higher confidence and outer lower confidence).

An axial view 1301, a coronal view 1302, and a sagittal view 1303 are given in FIG. 13.

In the views, an inner cuboid 1304 and an outer cuboid 1305 illustrate the localization of the infarct region at different levels of confidence.

Confidence regions may be derived from the points of intersection of the curves 803, 804 in FIG. 8 corresponding to different combinations of P_r and threshold intensities.

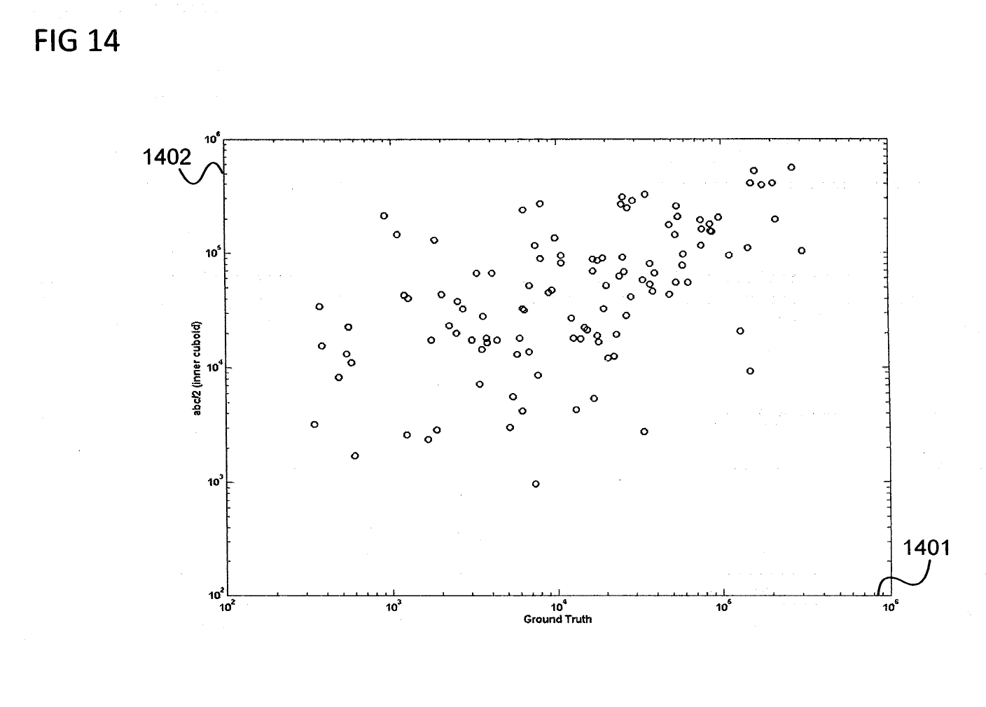

Using the estimated cuboid region the volume of the infarct may be calculated using standard abc/2 method (or any other formula utilizing the dimensions of cuboid). The volume is highly proportional to the ground truth volume of the infarct as illustrated in FIG. 14.

FIG. 14 illustrates the correlation of the volume of the inner cuboid 1304 and the ground truth volume.

The ground truth volume increases along a first axis 1401 and the volume of the inner cuboid 1304 increases along as second axis 1402.

Thus prediction of the volume by the abc/2 method (or any other formula utilizing the dimensions of cuboid) allows automatic and unbiased determination of the volume, in contrast to determination of the dimensions a, b, c from segmentation or manually (e.g. by a clinician marking boundaries).

Embodiments allow the infarct to be identified, localized and quantified promptly. They are useful clinically in screening the scans for the infarct. This potentially will increase the sensitivity of unenhanced CT in acute stroke identification. Embodiments can also be used in infarct segmentation and quantification, as an initial approximation of infarct localization and extent as well as in 3D display (e.g., by means of volume rendering of the cuboidal region encompassing the infarct). The analysis presented above and embodiments are also applicable to detect old infarcts.

According to an embodiment, a method to identify, localise and estimate spatial characteristics of an acute infarct using histogram derived from unenhanced CT scans without performing the actual segmentation of acute infarct is provided. This allows doctors to decide and perform the necessary action in lesser amount of time in an emergency room when a stroke patient is admitted. Embodiments may for example include
Identification of infarct/non infarct of brain region in unenhanced CT scans based on a calculated CT parameter derived from the change (differences in left and right hemisphere) in histogram characteristics of the images in the parenchyma intensity range.
Localisation of the infarct region by using CT parameters to estimate the acute infarct hemisphere and the acute infarct slices in axial, coronal and sagittal planes & cuboidal volume of interest (also ellipse or any other shape).
Detection of swelling by using the changes in the number of voxels in hypointense CSF range.
Estimation of infarct core/center using region of maximum change in CTp in axial, coronal and sagittal planes.
Estimation of infarct volume using the volume prediction equation using data from calibrated ground truth.
Calibration of ground truth volume of an infarct using collected data for the changes in number of voxels in the acute infarct intensity region of target CT images. This enables the construction of the model equation to estimate an acute infarct volume without segmenting it.

1. A method for processing a computed tomography measurement result, the computed tomography measurement result comprising an intensity for each voxel of a plurality of voxels, wherein the method comprises:
determining, for each intensity of a range of intensities, the number of voxels of the plurality of voxels for which the intensity has been determined; and
determining a characteristic of a target body region based on the determined numbers of voxels of the plurality of voxels.

2. The method according to claim 1, wherein the computed tomography measurement result further comprises a intensity for each voxel of a further plurality of voxels and wherein the method further comprises determining, for each intensity of a range of intensities, the number of voxels of the further plurality of voxels for which the intensity has been determined, comparing the determined numbers of voxels of the plurality of voxels and the determined numbers of voxels of the further plurality of voxels, and determining the characteristic of the target body region based on the result of the comparison.

3. The method according to claim 2, wherein the computed tomography measurement result comprises an intensity for each voxel of a multiplicity of voxels and the method further comprises selecting the plurality of voxels and the further plurality of voxels from the multiplicity of voxels.

4. The method according to any one of claims 1 to 3, wherein determining the characteristic of the target body region comprises determining whether the target body region is afflicted by an illness.

5. The method according to any one of claims 1 to 4, wherein determining the characteristic of the target body region comprises estimating a size of a part of the target body region.

6. The method according to claim 5, wherein the part of the target body region is a part of the target body region afflicted by an illness.

7. The method according to any one of claims 1 to 6, wherein determining the characteristic of the target body region comprises estimating the position of a part of the target body region afflicted by an illness.

8. The method according to any one of claims 1 to 7, wherein the illness is an infarct.

9. The method according to any one of claims 1 to 8, wherein the target body region is at least a part of the brain.

10. The method according to any one of claims 1 to 9, wherein determining the characteristic of the target body region comprises determining whether there is brain swelling in the target body region.

11. The method according to any one of claims 1 to 10, wherein determining the characteristic of the target body region comprises determining a numerical parameter indicative of the characteristic of the target body region.

12. The method according to claim 11, wherein determining the characteristic of the target body region comprises comparing the determined numerical parameter with a reference value of the numerical parameter.

13. The method according to claim 12, wherein the reference value of the numerical parameter is a value of the numerical parameter determined for another body region than the target body region.

14. The method according to any one of claims 11 to 13, wherein the numerical parameter is determined based on the determined numbers of voxels.

15. The method according to claim 14, wherein the numerical parameter is determined based on at least one of a mean of the numbers of voxels over the range of intensities, a median of the numbers of voxels over the range of intensities, a ratio of differences of percentiles of the numbers of voxels over the range of intensities, and a ratio of numbers of voxels of different sub-ranges of the range of intensities.

16. The method according to any one of claims 1 to 15, further comprising receiving the computed tomography measurement result.

17. A device for processing a computed tomography measurement result, the computed tomography measurement result comprising an intensity for each voxel of a plurality of voxels, wherein the device comprises:
a first determining circuit, configured to determine for each intensity of a range of intensities, the number of voxels of the plurality of voxels for which the intensity has been determined; and
a second determining circuit configured to determine a characteristic of a target body region based on the determined numbers of voxels of the plurality of voxels.

18. A computer program element, which, when executed by a computer, makes the computer perform a method for processing a computed tomography measurement result, the computed tomography measurement result comprising an intensity for each voxel of a plurality of voxels, wherein the method comprises:
determining, for each intensity of a range of intensities, the number of voxels of the plurality of voxels for which the intensity has been determined; and
determining a characteristic of a target body region based on the determined numbers of voxels of the plurality of voxels.

19. A method for processing a computed tomography measurement result, the computed tomography measurement result comprising an intensity for each voxel of a plurality of voxels, wherein the method comprises:
determining a first subgroup of the plurality of voxels and a second subgroup of the plurality of voxels;
determining, for each intensity of a range of intensities, the number of voxels of the first subgroup of voxels for which the intensity has been determined;
determining, for each intensity of a range of intensities, the number of voxels of the second subgroup of voxels for which the intensity has been determined;
comparing the determined numbers of voxels of the first subgroup and the determined numbers of voxels of the second subgroup; and
determining a characteristic of a target body region based on the result of the comparison.
